(19) United States
(12) Patent Application Publication
(10) Pub. No.: US 2022/0008990 A1
(43) Pub. Date: Jan. 13, 2022

(54) BATTERIES AND ELECTRODES WITH COATED ACTIVE MATERIALS

(71) Applicant: IONIC MATERIALS, INC., Woburn, MA (US)

(72) Inventors: Alexei B. Gavrilov, Woburn, MA (US); Alexander Mohamed, Medford, MA (US)

(73) Assignee: IONIC MATERIALS, INC., Woburn, MA (US)

(21) Appl. No.: 17/292,651

(22) PCT Filed: Nov. 27, 2019
(86) PCT No.: PCT/US2019/063562

§ 371 Date: May 10, 2021

Related U.S. Application Data
(60) Provisional application No. 62/773,789, filed on Nov. 30, 2018.

(51) Int. Cl. B22F 1/02; H01M 4/36; H01M 4/38; H01M 4/60; H01M 4/50; H01M 4/62; H01M 10/0562

(52) U.S. Cl. CPC B22F 1/02; H01M 4/366; H01M 4/382; H01M 4/602; H01M 2004/021; H01M 4/623; H01M 4/625; H01M 10/0562; H01M 4/502

(57) ABSTRACT

A coating composition is described. The coating composition has a plurality of particles of a solid, ionically conductive polymer material. The solid, ionically conductive polymer material has an ionic conductive greater than 1×10-4 S/cm at room temperature, and the solid, ionically conductive polymer material is in a glassy state at room temperature. The coating composition also has a plurality of particles of an electrically conductive material. The electrically conductive material has an electrical conductivity at room temperature greater that 1×102 S/cm. The coating composition additionally has a plurality of particles of a binder. The binder holds the particles of the composition to form a cohesive coating. Battery and battery components using the coating composition are also described.

### STATEMENT REGARDING FEDERALLY SPONSORED RESEARCH OR DEVELOPMENT

Not Applicable.

### BACKGROUND OF THE INVENTION

Primary alkaline batteries are the main choice for consumer batteries. The main ingredient for active materials in the cathode is manganese dioxide, which is a well-known electrochemical material being used in alkaline batteries for over 30 years.

Referring to reaction equation (i), during battery discharge, the Mn(IV) in the manganese oxide undergoes reduction to Mn(III), accompanied by proton intercalation into the manganese oxide structure.

MnO₂+e⁻+H₂O→MnOOH+OH⁻ (i)

The MnOOH product of reaction (i) forms a solid with the remaining reactant MnO₂ and the composition is described as MnOOHₓ. Referring to FIG. 1, the formation of soluble manganese (III) species at x>0.6 leads to formation of Hausmannite and Hataerolite via a dissolution-precipitation mechanism. Both products are substantially electrochemically inactive and lead to an increase in cell impedance, thus limiting available capacity. An embodiment of the invention has been found to prevent the side reactions and associated dissolution leading to an increase in available battery capacity. Other embodiments of the invention have been found to improve electrode and battery performance in numerous other electrochemical systems.

### BRIEF SUMMARY OF THE INVENTION

The present invention features coatings and/or coating compositions, particles having coatings and/or coated particles, electrodes including cathodes, batteries including primary batteries, battery components and/or battery systems for utilization of electrolytic manganese dioxide or EMD, other manganese oxides, and other electroactive materials in a more electrochemically efficient manner.

In a first aspect, an embodiment provides a coating which includes a solid, ionically conductive polymer having an ionic conductivity of at least 1×10⁴ S/cm at room temperature. The solid, ionically conductive polymer being in a glassy state. The coating also includes an electrically conductive material including carbon and having an electrical conductivity of at least 1×10² S/cm at room temperature.

In a further aspect, an embodiment provides a particle having a coating. The particle includes a manganese oxide. The coating includes a solid, ionically conductive polymer having an ionic conductivity of at least 1×10⁻⁴ S/cm at room temperature. The solid, ionically conductive polymer being in a glassy state. The coating also has an electrically conductive material including carbon.

In another aspect, an embodiment provides a cathode. The cathode includes a plurality of manganese oxide particles. Each of the manganese oxide particles has a coating which includes a solid, ionically conductive polymer having an ionic conductivity of at least 1×10⁻⁴ S/cm at room temperature. The solid, ionically conductive polymer being in a glassy state. The coating also has an electrically conductive material including carbon.

In a further aspect, an embodiment provides a primary battery. The primary battery has a cathode including a plurality of manganese oxide particles. One or more of the manganese oxide particles has a coating which includes a solid, ionically conductive polymer having an ionic conductivity of at least 1×10⁻⁴ S/cm at room temperature. The solid, ionically conductive polymer being in a glassy state. The coating also has an electrically conductive material including carbon.

In another aspect, an embodiment provides a coating composition. The coating composition has a plurality of particles of a solid, ionically conductive polymer material. The solid, ionically conductive polymer material has an ionic conductive greater than 1×10⁴ S/cm at room temperature, and the solid, ionically conductive polymer material is in a glassy state at room temperature. The coating composition also has a plurality of particles of an electrically conductive material. The electrically conductive material has an electrical conductivity at room temperature greater that 1×10² S/cm. The coating composition additionally has a plurality of particles of a binder. The binder holds the particles of the composition to form a cohesive coating.

### BRIEF DESCRIPTION OF THE SEVERAL VIEWS OF THE DRAWINGS

The appended drawings support the detailed description of the invention and refer to exemplary embodiments. The appended drawings are considered to be in no way limiting to the full scope of the invention.

In the drawings:

FIG. 1 is a schematic showing how coating according to an embodiment of the invention hinders side reactions which would otherwise lead to the formation of undesirable species;

FIG. 2 shows representative SEM images of dried coating layer or ink, uncoated EMD particles or powder and EMD particles or powder following coating with the coating layer or ink according to exemplary embodiments of the invention;

FIG. 3 shows representative XPS results for uncoated versus coated EMD material according to an embodiment of the invention;

FIG. 4. shows discharge curves of a commercial AA cell with uncoated manganese oxide as compared to an AA cell with coated manganese oxide according to an embodiment of the invention with;

FIG. 5 is a schematic of the coating concept according to an embodiment of the invention;

FIG. 6 shows XPS spectra of uncoated Zinc powder and Zinc powder coated according to an embodiment of the invention;

FIG. 7. Shows the cycle life of 2032 coin cells with uncoated Zinc powder (lower curve) and Zinc powder coated according to an embodiment of the invention (upper curve);

FIG. 8. Shows XPS spectra of uncoated Aluminum powder and Aluminum powder coated according to an embodiment of the invention;

FIG. 9 shows a potentiodynamic curve for an uncoated Aluminum (curve on FIG. right) in comparison with a potentiodynamic curve for coated Aluminum (curve on left) according to an embodiment of the invention;

FIG. 10 shows a comparison of discharge curves for EMD cells, and cells according to Example 14 without polymer coating and with polymer coating according to an embodiment of the invention;

FIG. 11 shows box and whiskers plots overlaid with swamp plots of cells having lithium metal anodes, polymer electrolyte separators and LCO-polymer electrolyte composite cathodes according to an embodiment of the invention;

FIG. 12 (a) shows particle size distribution of solid polymer electrolyte according to an embodiment of the invention;

FIG. 12 (b) shows surface morphology and roughness of dried coating prepared on copper foil according to an embodiment of the invention;

FIG. 12 (c) shows a top-down scanning electron micrograph of a coating prepared on copper foil according to an embodiment of the invention;

FIG. 12 (d) shows a cross-section scanning electron micrograph of a coating prepared on copper foil according to an embodiment of the invention;

FIG. 13 (a) shows electrochemical impedance spectra of uncoated Li metal cells and coated Li metal cells according an embodiment of the invention; and

FIG. 13 (b) shows cycling performance of uncoated and coated Li cells in Li/PE/NCM811 cells according to an embodiment of the invention.

### DETAILED DESCRIPTION OF THE INVENTION

An electroactive material is a synonym of electrochemically active substance, i.e., a substance which changes its oxidation state, or partakes in a formation or breaking of chemical bonds, in a charge-transfer step of an electrochemical reaction and electrochemically active material.

Solid electrolytes include solvent free polymers, and ceramic compounds (crystalline and glasses).

A “Solid” is characterized by the ability to keep its shape over an indefinitely long period, and is distinguished and different from a material in a liquid phase. The atomic structure of solids can be either crystalline or amorphous. Solids can be mixed with or be components in composite structures. However, for purposes of this application and its claims, a solid material requires that that material be ionically conductive through the solid and not through any solvent, gel or liquid phase, unless it is otherwise described. For purposes of this application and its claims, gelled (or wet) polymers and other materials dependent on liquids for ionic conductivity are defined as not being solid electrolytes in that they rely on a liquid phase for their ionic conductivity.

A polymer is typically organic and comprised of carbon based macromolecules, each of which have one or more type of repeating units or monomers. Polymers are light-weight, ductile, usually non-conductive and melt at relatively low temperatures. Polymers can be made into products by injection, blow and other molding processes, extrusion, pressing, stamping, three dimensional printing, machining and other plastic processes. Polymers typically have a glassy state at temperatures below the glass transition temperature Tg. This glass temperature is a function of chain flexibility, and occurs when there is enough vibrational (thermal) energy in the system to create sufficient free-volume to permit sequences of segments of the polymer macromolecule to move together as a unit. However, in the glassy state of a polymer, there is no segmental motion of the polymer.

Polymers are distinguished from ceramics which are defined as inorganic, non-metallic materials; typically compounds consisting of metals covalently bonded to oxygen, nitrogen or carbon, brittle, strong and non-conducting.

The glass transition, which occurs in some polymers, is a midpoint temperature between the supercooled liquid state and a glassy state as a polymer material is cooled. The thermodynamic measurements of the glass transition are done by measuring a physical property of the polymer, e.g. volume, enthalpy or entropy and other derivative properties as a function of temperature. The glass transition temperature is observed on such a plot as a break in the selected property (volume of enthalpy) or from a change in slope (heat capacity or thermal expansion coefficient) at the transition temperature. Upon cooling a polymer from above the Tg to below the Tg, the polymer molecular mobility slows down until the polymer reaches its glassy state.

It is important to note that the ionic conductivity is different from electrical conductivity. Ionic conductivity depends on ionic diffusivity, and the properties are related by the Nernst-Einstein equation. Ionic conductivity and ionic diffusivity are both measures of ionic mobility. An ionic is mobile in a material if its diffusivity in the material is positive (greater than zero), or it contributes to a positive conductivity. All such ionic mobility measurements are taken at room temperature (around 21° C.), unless otherwise stated. As ionic mobility is affected by temperature, it can be difficult to detect at low temperatures. Equipment detection limits can be a factor in determining small mobility amounts. Mobility can be understood as diffusivity of an ion at least 1×10⁻¹⁴ m²/s and preferably at least 1×10⁻¹³ m²/s, which both communicate an ion is mobile in a material.

A solid polymer ionically conducting material is a solid that comprises a polymer and that conducts ions as will be further described.

An aspect of the present invention includes a method of synthesizing a solid ionically conductive polymer material from at least three distinct components: a polymer, a dopant and an ionic compound. The components and method of synthesis are chosen for the particular application of the material. The selection of the polymer, dopant and ionic compound may also vary based on the desired performance of the material. For example, the desired components and method of synthesis may be determined by optimization of a desired physical characteristic (e.g. ionic conductivity).

### Synthesis:

The method of synthesis can also vary depending on the particular components and the desired form of the end material (e.g. film, particulate, etc.). However, the method includes the basic steps of mixing at least two of the components initially, adding the third component in an optional second mixing step, and heating the components/reactants to synthesis the solid ionically conducting polymer material in a heating step. In one aspect of the invention, the resulting mixture can be optionally formed into a film of desired size. If the dopant was not present in the mixture produced in the first step, then it can be subsequently added to the mixture while heat and optionally pressure (positive pressure or vacuum) are applied. All three components can be present and mixed and heated to complete the synthesis of the solid ionically conductive polymer material in a single step. However, this heating step can be done when in a separate step from any mixing or can completed while mixing is being done. The heating step can be performed regardless of the form of the mixture (e.g. film, particulate, etc.) In an aspect of the synthesis method, all three components are mixed and then extruded into a film. The film is heated to complete the synthesis.

When the solid ionically conducting polymer material is synthesized, a color change occurs which can be visually observed as the reactants color is a relatively light color, and the solid ionically conducting polymer material is a relatively dark or black color. It is believed that this color change occurs as charge transfer complexes are being formed, and can occur gradually or quickly depending on the synthesis method.

An aspect of the method of synthesis is mixing the base polymer, ionic compound and dopant together and heating the mixture in a second step. As the dopant can be in the gas phase, the heating step can be performed in the presence of the dopant. The mixing step can be performed in an extruder, blender, mill or other equipment typical of plastic processing. The heating step can last several hours (e.g. twenty-four (24) hours) and the color change is a reliable indication that synthesis is complete or partially complete. Additional heating past synthesis does not appear to negatively affect the material.

In an aspect of the synthesis method, the base polymer and ionic compound can be first mixed. The dopant is then mixed with the polymer-ionic compound mixture and heated. The heating can be applied to the mixture during the second mixture step or subsequent to the mixing step.

In another aspect of the synthesis method, the base polymer and the dopant are first mixed, and then heated. This heating step can be applied after the mixing or during, and produces a color change indicating the formation of the charge transfer complexes and the reaction between the dopant and the base polymer. The ionic compound is then mixed to the reacted polymer dopant material to complete the formation of the solid ionically conducting polymer material.

Typical methods of adding the dopant are known to those skilled in the art and can include vapor doping of a film containing the polymer and ionic compound and other doping methods known to those skilled in the art. Upon doping the solid polymer material becomes ionically conductive, and it is believed that he doping acts to activate the ionic components of the solid polymer material so they are diffusing ions.

Other non-reactive components can be added to the above described mixtures during the initial mixing steps, secondary mixing steps or mixing steps subsequent to heating. Such other components include but are not limited to depolarizers or electrochemically active materials such as anode or cathode active materials, electrically conductive materials such as carbons, rheological agents such as binders or extrusion aids (e.g. ethylene propylene diene monomer “EPDM”), catalysts and other components useful to achieve the desired physical properties of the mixture.

Polymers that are useful as reactants in the synthesis of the solid ionically conductive polymer material are electron donors or polymers which can be oxidized by electron acceptors. Semi-crystalline polymers with a crystallinity index greater than 30%, and greater than 50% are suitable reactant polymers. Totally crystalline polymer materials such as liquid crystal polymers (“LCPs”) are also useful as reactant polymers. LCPs are totally crystalline and therefore their crystallinity index is hereby defined as 100%. Undoped conjugated polymers and polymers such as polyphenylene sulfide (“PPS”) are also suitable polymer reactants.

Polymers are typically not electrically conductive. For example, virgin PPS has electrical conductivity of 10⁻²⁰ S cm⁻¹. Non-electrically conductive polymers are suitable reactant polymers.

In an aspect, polymers useful as reactants can possess an aromatic or heterocyclic component in the backbone of each repeating monomer group, and a heteroatom either incorporated in the heterocyclic ring or positioned along the backbone in a position adjacent the aromatic ring. The heteroatom can be located directly on the backbone or bonded to a carbon atom which is positioned directly on the backbone. In both cases where the heteroatom is located on the backbone or bonded to a carbon atom positioned on the backbone, the backbone atom is positioned on the backbone adjacent to an aromatic ring. Non-limiting examples of the polymers used in this aspect of the invention can be selected from the group including PPS, Poly(p-phenylene oxide)(“PPO”), LCPs, Polyether ether ketone (“PEEK”), Polyphthalamide (“PPA”), Polypyrrole, Polyaniline, and Polysulfone. Co-polymers including monomers of the listed polymers and mixtures of these polymers may also be used. For example, copolymers of p-hydroxybenzoic acid can be appropriate liquid crystal polymer base polymers. Table 1 details non-limiting examples of reactant polymers useful in the present invention along with monomer structure and some physical property information which should be considered also non-limiting as polymers can take multiple forms which can affect their physical properties.

TABLE 1

| | | Melting | |
|---|---|---|---|
| Polymer | Monomer Structure | Pt. (C) | MW |
| PPS polyphenylene sulfide | 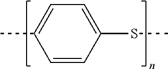 | 285 | 109 |
| PPO Poly (p- phenylene oxide) | 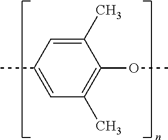 | 262 | 92 |
| PEEK Polyether ether ketone | 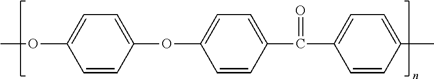 | 335 | 288 |
| PPA Polypthalamide | 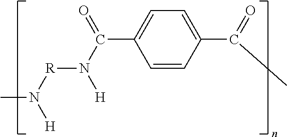 | 312 | |
| Polypyrrole | 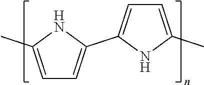 | | |
| Polyaniline Poly- Phenylamine [C₆H₄NH]ₙ | 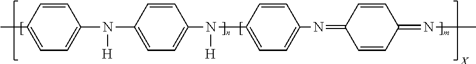 | 385 | 442 |
| Polysulfone | 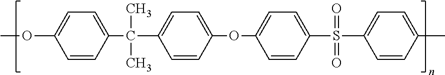 | | 240 |
| Xydar (LCP) | 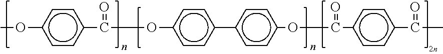 | | |
| Vectran Poly- paraphenylene terephthalamide [—CO—C₆H₄—CO—NH—C₆H₄—NH—]ₙ | 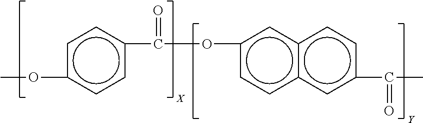 | | |
| Polyvinylidene fluoride (PVDF) | 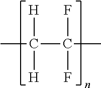 | 177° C. | |
| Polyacrylonitrile (PAN) | 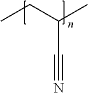 | 300° C. | |
| Polytetrafluoro- ethylene (PTFE) | 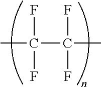 | 327 | |
| Polyethylene (PE) | 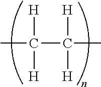 | 115-135 | |

Dopants that are useful as reactants in the synthesis of the solid ionically conductive polymer material are electron acceptors or oxidants. It is believed that the dopant acts to release ions for ionic transport and mobility, and it is believed to create a site analogous to a charge transfer complex or site within the polymer to allow for ionic conductivity. Non-limiting examples of useful dopants are quinones such as: 2,3-dicyano-5,6-dichlorodicyanoquinone (C₈Cl₂N₂O₂) also known as “DDQ”, and tetrachloro-1,4-benzoquinone (C₆Cl₄O₂), also known as chloranil, tetracyanoethylene (C₆N₄) also known as TCNE, sulfur trioxide (“SO₃”), ozone (trioxygen or O₃), oxygen (O₂, including air), transition metal oxides including manganese dioxide (“MnO₂”), or any suitable electron acceptor, etc. and combinations thereof. Dopants are those that are temperature stable at the temperatures of the synthesis heating step are useful, and quinones and other dopants which are both temperature stable and strong oxidizers quinones are most useful. Table 2 provides a non-limiting listing of dopants, along with their chemical diagrams.

TABLE 2

| Dopant | Formula | Structure |
|---|---|---|
| 2,3-Dichloro-5,6-dicyano-1,4- benzoquinone (DDQ) | C₆Cl₂(CN)₂O₂ | 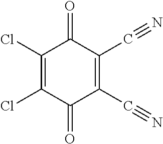 [SMILES: N#CC1=C(C#N)C(=O)C(Cl)=C(Cl)C1=O] |
| tetrachloro-1,4-benzoquinone (chloranil) | C₆Cl₄O₂ | 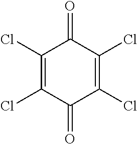 [SMILES: O=C1C(Cl)=C(Cl)C(=O)C(Cl)=C1Cl] |
| Tetracyanoethylene (TCNE) | C₆N₄ | 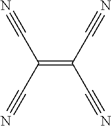 |
| Sulfur Trioxide | SO₃ | |
| Ozone | O₃ | |
| Oxygen | O₂ | |
| Transition Metal Oxides | MO₂ (M = Transition Metal) | |

Ionic compounds that are useful as reactants in the synthesis of the solid ionically conductive polymer material are compounds that release desired ions during the synthesis of the solid ionically conductive polymer material. The ionic compound is distinct from the dopant in that both an ionic compound and a dopant are required. Non-limiting examples include Li₂O, LiOH, ZnO, TiO₂, Al₃O₂, NaOH, KOH, LiNO₃, Na₂O, MgO, CaCl₂, MgCl₂, AlCl₃, LiTFSI (lithium bis-trifluoromethanesulfonimide), LiFSI (Lithium bis(fluorosulfonyl)imide), Lithium bis(oxalato)borate (LiB(C₂O₄)₂ “LiBOB”) and other lithium salts and combinations thereof. Hydrated forms (e.g. monohydride) of these compounds can be used to simplify handling of the compounds. Inorganic oxides, chlorides and hydroxide are suitable ionic compounds in that they dissociate during synthesis to create at least one anionic and cationic diffusing ion. Any such ionic compound that dissociates to create at least one anionic and cationic diffusing ion would similarly be suitable. Multiple ionic compounds can also be useful that result in multiple anionic and cationic diffusing ions can be preferred. The particular ionic compound included in the synthesis depends on the utility desired for the material. For example, in an application where it would be desired to have a lithium cation, a lithium hydroxide, or a lithium oxide convertible to a lithium and hydroxide ion would be appropriate. As would be any lithium containing compound that releases both a lithium cathode and a diffusing anion during synthesis. A non-limiting group of such lithium ionic compounds includes those used as lithium salts in organic solvents. Similarly, an aluminum or other specific ionic compound reacts to release the specific desired ion and a diffusing anion during synthesis in those systems where an aluminum or other specific cation is desired. As will be further demonstrated, ionic compounds including alkaline metals, alkaline earth metals, transition metals, and post transition metals in a form that can produce both the desired cationic and anionic diffusing species are appropriate as synthesis reactant ionic compounds.

The purity of the materials is potentially important so as to prevent any unintended side reactions and to maximize the effectiveness of the synthesis reaction to produce a highly conductive material. Substantially pure reactants with generally high purities of the dopant, base polymer and the ionic compound are preferred, and purities greater than 98% are more preferred with even higher purities, e.g. LiOH: 99.6%, DDQ: >98%, and Chloranil: >99% most preferred.

To further describe the utility of the solid ionically conductive polymer material and the versatility of the above described method of the synthesis of the solid ionically conductive polymer material of the present invention, several classes of the solid ionically conductive polymer material useful for multiple electrochemical applications and distinguished by their application are described:

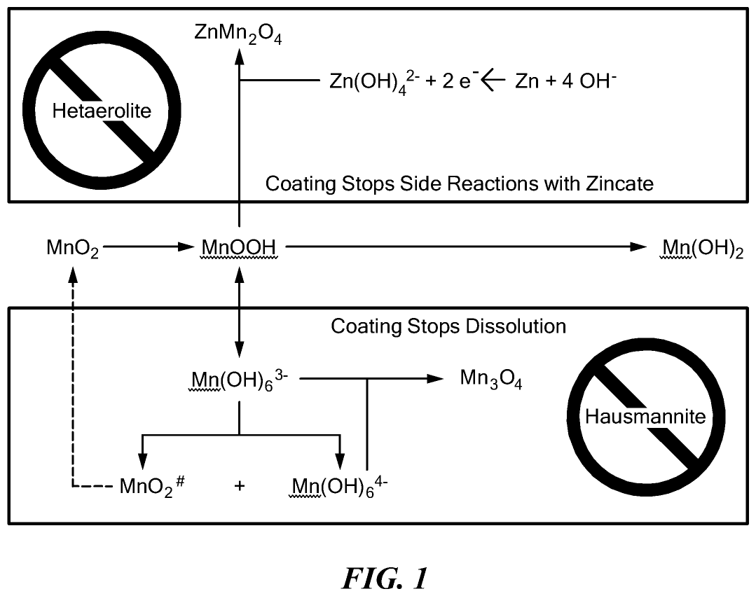

It is desired to remedy the performance inefficiency discussed above so as to utilize electrolytic manganese dioxide or EMD and other manganese oxides in a more electrochemically efficient manner. Referring again to the schematic of FIG. 1, the encapsulation of manganese oxide particles with an ionically and electrically conductive coating hinders diffusion of manganese (III) species and zincate ions, while conducting hydroxyl ions and electrons which enables further reduction of MnOOH, thus increasing capacity.

In one aspect, the invention features coated manganese oxide particles. In a preferred embodiment the invention features coated manganese dioxide particles, and in a more preferred embodiment, coated EMD particles. The manganese oxide particles are coated in a two-step process using the ionically conductive material.

During a first step, the ionically conductive material is wet-mixed with an electronically conducting agent in a select proportion thereby forming a coating, such as a coating layer or coating ink. During a second step, the coating is combined with the manganese oxide particles, in a solvent and mixed followed by drying and curing. In one embodiment, an elastic polymer can be added to the wet mixture to improve the mechanical stability of the wet mixture. Alternatively, an elastic polymer can be added to the dried mixture for improved mechanical stability of the dried mixture. The elastic polymer can be selected from elastic polymers known to those of ordinary skill in the art, particularly, the painting and coating arts.

After the second step, the resulting dried and cured material can be mixed further with graphite and KOH and used to build an alkaline AA cell utilizing materials and/or processes commonly known to those of ordinary skill in the art in the art of the alkaline battery industry. Alternatively, other additives specific to other battery types, as known by those of ordinary skill in the art, can be mixed with the resulting dried and cured material for building the corresponding battery types.

In another aspect, the invention features a coating such as a coating layer or ink including an ionically conductive polymer and a water component forming a mixture having a solids content of between 7 and 20 wt. %. One or more electronically conductive agents, such as, for example, a carbon component(s) is or are added to the mixture. The electronically conductive carbon component can include graphene, graphite, carbon black, carbon nanotubes and a combination of one or more of the aforementioned components in select ratios.

The electronically conductive carbon component(s) is or are incorporated into the mixture using a high shear mixing method. The high shear mixing method deagglomerates the carbon component(s) and homogenizes the polymer water carbon mixture. During the high shear mixing process, in one preferred embodiment, a binder such as a second polymeric material can be added to the mixture. The second polymeric material can optionally include a crosslinking agent.

After mixing, the resulting material is placed onto an active material and dried. The dried layer forms a protective coating for the active material and is both ionically and electronically conductive.

### Example 1

PPS polymer was mixed with the ionic compound LiOH monohydrate in the proportion of 67% to 33% (by wt.), respectively, and mixed using jet milling. DDQ (alternatively oxygen is used) dopant was added via vapor doping to the resulting mixture in the amount of 1 mole of DDQ per 4.2 moles of PPS monomer. The mixture was heat treated at 190-200° C. for 30 minutes under moderate pressure (500-1000 PSI) to yield ionically conductive polymer which can conduct hydroxyl ion. Via differential scanning calorimetry (“DSC” method described in ASTM D7426 (2013)) the glassy state extends below the temperature range below the material melting temperature to at least room temperature, where the ionic conductivity was found to exceed 1×10⁴ S/cm.

A 45.6 gram suspension consisting of 8.22 wt. % submicron ionically conductive polymer flakes in distilled water was combined with 24.44 grams of deionized water. A rotor-stator high shear homogenizer was used to mix the polymer water suspension at 3500 rpm. An amount of 5.6 grams of carbon having a 1:1 ratio of carbon black and graphene aggregates was slowly added to the polymer water suspension while increasing the rpm of the mixing head to 6500 rpm. After mixing at 6500 rpm for five minutes, 1.18 grams of styrene-butadiene rubber aqueous emulsion with 6% carboxylate was added drop wise to the mixture while increasing the rpm of the mixing head to 900 rpm. The mixture was mixed for an additional three minutes.

### Example 2

A 45.6 gram suspension consisting of 8.22 wt. % submicron ionically conductive polymer (from Example 1) flakes in distilled water was combined with 24.44 grams of deionized water. The mixture and ten 10 mm ZrO₂ balls were placed inside a 125 mL ZrO₂ ball mill canister. An amount of 5.6 grams of carbon having a 1:1 ratio of carbon black and graphene aggregates was added to the canister. The materials were mixed using a planetary ball mill at 300 rpm for thirty minutes during a first mixing stage. After the first mixing stage, the ball mill canister was opened and 1.18 grams of styrene-butadiene rubber aqueous emulsion with 6% carboxylate was added to the canister and the canister contents were further mixed on the planetary ball mill at 300 rpm for thirty minutes during a second mixing stage. After the second mixing stage, the material was separated from the ZrO₂ balls.

### Example 3

A 45.6 gram suspension consisting of 8.22 wt. % submicron ionically conductive polymer flakes (from Example 1) in distilled water was combined with 5.92 grams of 10 wt. % aqueous polyvinyl alcohol and 18.48 grams of deionized water. The suspension was mixed using a rotor stator homogenizing head at 3000 rpm. An amount of 5.6 grams of carbon having a 1:1 ratio of carbon black and graphene aggregates was slowly added to the mixture while increasing the mix speed to 6000 rpm. An amount of 1.48 grams of 10 wt. % aqueous glutaraldehyde was added to the mixture, and the mixture mixed for five minutes. Two drops of 0.1 M HCl were added to the mixture to initiate crosslinking between glutaraldehyde and polyvinyl alcohol. After the HCl was added to the mixture, the mixture was coated onto the active material within thirty minutes to avoid the mixture becoming too stiff, solid, non-liquid, non-fluid or otherwise non-workable for coating.

### Example 4

The material from each of Examples 1, 2 and 3 in an amount of 14.3 grams and 15 wt. % solids was separately combined with 0.67 grams of 45 wt. % KOH solution and 14.4 grams of deionized water in a corresponding large 300 mL THINKY container. An amount of 100 grams of electrolytic manganese dioxide particles was added to each mixture contained within the corresponding THINKY container. Each combination was mixed for five minutes at 2000 rpm. Afterwards each THINKY container was placed in a 70° C. oven and dried to 50% of the original moisture content for initiating curing of the coating. Such curing was conducted to ensure adhesion of the coating to the surface of the manganese oxide particles. After partial drying, 3.3 grams of a graphite mix containing expanded and synthetic graphite was added to each mixture in each THINKY container and each mixture was then mixed for five minutes at 2000 rpm. The material from each THINKY container was then placed in an oven at 70-90° C. for overnight drying.

### Example 5

For each of the materials prepared in Examples 1, 2 and 3, an amount of 2500 grams of electrolytic manganese dioxide particles was substantially evenly distributed in a corresponding large mixing container or bowl. The particles were mixed using a mixer device with an impeller speed of 2-3 corresponding to 100-200 rpm. During such mixing, an amount of 468 grams of the material from each of Examples 1, 2 and 3, each including approximately 11.7 wt. % solids, was injected slowly into each of the three mixing containers. After approximately 50% of the material from each of Examples 1, 2 and 3 was injected into each of their respective mixing containers, a high-speed chopper mechanism was activated by setting the dial at 3-4 corresponding to 8000-11000 rpm and used to mix further the contents in each of the three mixing containers. The remaining 50% of the material from each of Examples 1, 2 and 3 was injected into each of the mixing containers during the further mixing with the speed chopper mechanism.

The mixer device was then stopped, and material caked to blades and/or the walls of each of the mixing containers was scraped off and added to each of the corresponding mixed contents. Mixing was continued for approximately three more minutes, and then halted for further scraping of caked material from the blades and/or walls of each of the mixing containers. The mixing-scraping cycle was repeated at least three times, or further until the granulate including the now wetted particles no longer appeared to change in size and wetness.

Each mixing container and corresponding impeller from the mixer were separately placed in the oven at 70° C. until the moisture content of the granulate had been reduced by approximately 50%. The heating step began the curing of the coating for adherence of the coating to the surface of the manganese oxide particles.

Each mixing container including the granulate of wetted particles and mixer impeller were separately returned to the mixer device, and the impeller was re-secured to the mixer device. An amount of 82.4 grams of a graphite mix containing expanded and synthetic graphite was added to each mixing container containing the wetted particles. The mixing container was then closed and the contents mixed using an impeller speed of 2-3 and a chopper mechanism speed of 1, with periodic stoppages for blade and/or wall scraping. The mixing-scraping cycle was repeated for a total of three times for each mixing container. The material from each mixing container was separately transferred to a large stainless-steel pan and each stainless-steel pan was separately placed in the oven for overnight drying.

### Example 6

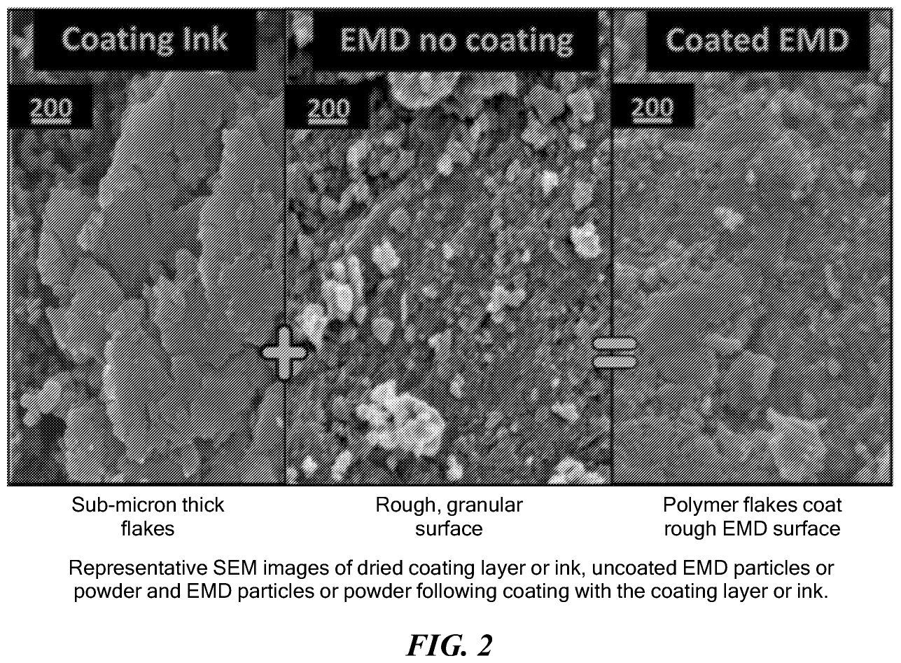

Scanning Electron Microscopy (SEM) was used to analyze and compare the coated EMD material produced according to Examples 4 and 5 with EMD powder having no coating and the dried coating layer or ink including ionically conductive polymer and carbon prepared according to Examples 1, 2 and 3. In the representative SEM images of FIG. 2, the coated EMD material has a relatively smooth surface and is visually similar to the dried coating layer or ink in contrast to the relatively rough surface of the uncoated EMD powder. Thus, FIG. 2 shows that the coating of the invention effectively covers the underlying EMD powder.

### Example 7

Coated EMD material produced according to Examples 4 and 5 and uncoated EMD material were analyzed using X-ray Photoelectron Spectroscopy (XPS) and compared with elemental analysis.

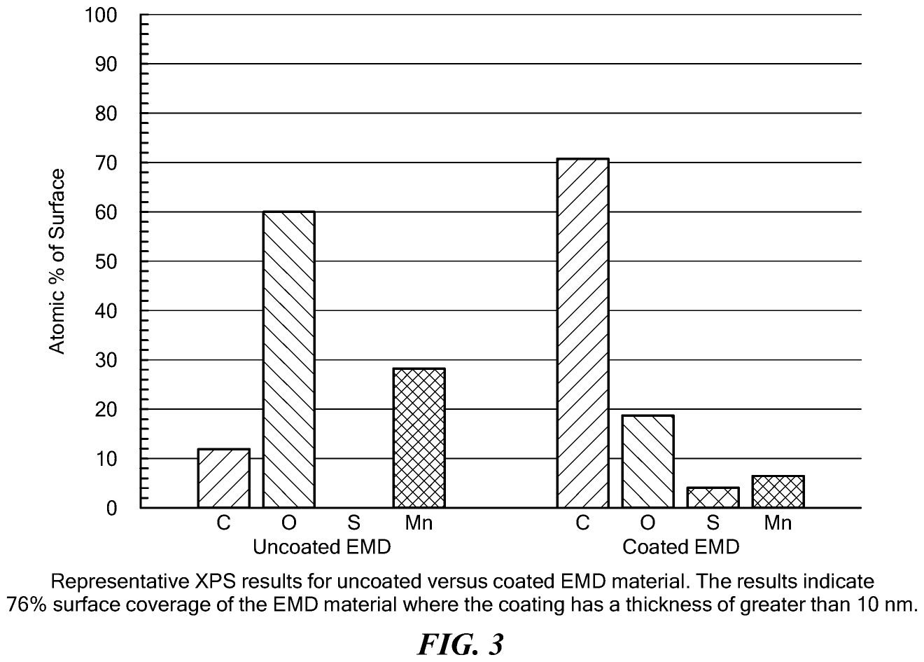

FIG. 3 shows the manganese (Mn) peak substantially reduced for the coated EMD material in comparison with the uncoated EMD material. XPS is a surface technique. Therefore, reduction of the Mn peak indicates surface coverage with a non-manganese containing material, that is with the polymer. At least 76% coverage of the surface of the EMD particles or EMD surface occlusion can be estimated based on the observed reduction in the Mn peak.

### Example 8

State of the art commercial cells were compared with AA cells produced with coatings prepared in accordance with Examples 4 and 5 of the present invention. Although the coated manganese oxide was substituted for uncoated manganese oxide, no other changes were made to the cell formulation. Both primary batteries included an electroactive zinc powder anode and an electroactive manganese dioxide cathode. The anode and cathode were disposed from each other by a porous separator. The electrolyte was a potassium hydroxide liquid solution which conducted hydroxyl ions and was dispersed throughout the cell contacting both the electroactive anode and the coated and uncoated cathode materials.

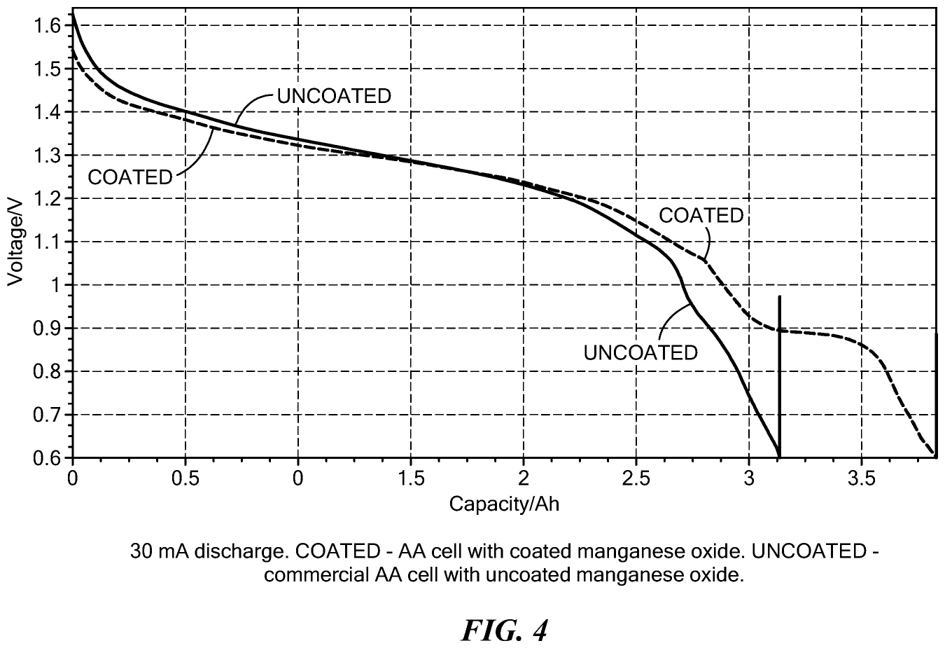

The AA cells produced with active material coatings in accordance with Examples 4 and 5 of the present invention demonstrated a capacity >20% higher than the state-of-the-art commercial AA cells. The coatings physically isolated the electroactive manganese oxide particles from the liquid electrolyte, while maintaining the ionic and electrical conductivity of the EMD. Referring to representative results shown in FIG. 4, the cells were discharged at 30 mA to a 0.6V cutoff. The cells produced with active material coatings in accordance with Examples 4 and 5 of the present invention demonstrated a capacity >20% higher than the uncoated manganese dioxide cells. Further, the cells produced with active material coatings in accordance with Examples 4 and 5 of the present invention achieved an OCV (open circuit voltage−pre-discharge) of greater than 1.5 V, and a capacity of greater than 3.0 Ahr at a 30 mA drain to a 0.8V cutoff.

In another aspect, encapsulation of EMD particles with a specifically formulated coating, which comprises an ionically conductive polymer is described. Such EMD particle encapsulation can suppress side reactions leading to formation of low active or inactive phases and enable access to the 2^{nd} electron capacity of manganese oxide in a primary cell.

In another aspect, the present invention describes a similar approach for secondary batteries which can be used to improve performance of other electroactive materials. As used herein, electroactive material includes electrochemically active materials used in both the cathode or anode.

The coating can be formulated to provide functionality as follows:
Provide ionic conductivity for a desired ion to move across the coating to/from the electroactive material from/to the bulk electrode;
Provide electron transport to move across the coating to/from the electroactive material from/to the bulk electrode;
Maintain chemical and electrochemical stability in the system of interest by isolating the electroactive material from the bulk electrode;
Provide mechanical stability, including being compliant so as to not crack under high levels of strain while maintaining adhesion with the electroactive particle during charge/discharge;
Increase overpotential for unwanted side-reactions;
Provide an ionically and electrically transition layer for transported ions; and
Provide segregation relative to the bulk electrode as the coating is non-permeable for undesired products and solvents.

Each specific chemistry, each with its electroactive materials, can be accommodated by tailoring properties of the coating and the ionically conductive polymer, selecting proper electronically conducting agent and binder and optimizing ratio of the components, as well as thickness of the coating.

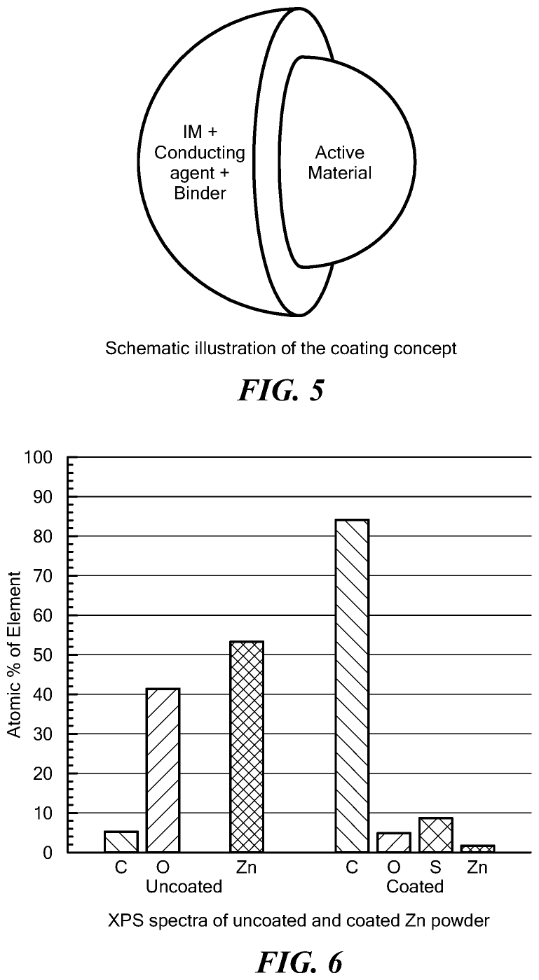

FIG. 5 shows a representative cutaway view of an electroactive material particle coated with the mixture of an ionically conductive polymer, an electrically conductive agent and a binder. Although not fully shown, the electroactive material particle has an external surface which is coated by the mixture which has a thickness extending from the particle surface to an external surface of the coating mixture. The coating creates a polymer electrolyte interface between the electroactive particle and the coating, and a barrier layer between the electroactive material and the bulk electrolyte (not shown).

After the coating is applied, the coated electroactive material can be used to fabricate electrodes utilizing conventional manufacturing methods and equipment. In turn, the electrode can be used to build cells using conventional technologies.

In different embodiments, this coating is applied to Zn, MnO₂ and Al particles for rechargeable alkaline systems, LCO particles for Li-ion batteries, and Lithium metal for lithium metal batteries.

The described coating can be useful in both solid-state batteries and batteries with a liquid or non-solid electrolyte. In batteries with non-solid electrolytes, the coating is useful to segregate the electroactive material from both an aqueous or non-aqueous electrolyte. The exterior surface of the coating forms a second interface with the bulk electrolyte, which in an aspect can be similar or the same as the coating formulation. In the instance when the coating formulation is different than the bulk electrolyte, electrons and migrating ions flow through the second interface while the coating can prevent flow of certain ions or molecule into the bulk electrolyte from the electroactive material.

The electroactive materials are most often in the form of a particle of uniform or non-uniform shape. The benefits of high surface area tend to require lower particle sizes, but variation in size for packing optimization for other reasons is also common as energy density is also desirous.

The coating provides protection and segregation from the bulk electrolyte, and can restrict ionic and molecular flow from the bulk electrolyte and from the electroactive particle to or into the bulk electrolyte. When coated, the surface of the particle no longer can participate in surface reactions with the bulk electrolyte. Protection is provided by keeping reaction products from migrating to the bulk electrolyte which can then react in a way that limits the capacity of the cell, e.g. reacting with the other electroactive material or bulk electrolyte. Thus, the tendency of such a surface reaction or reaction product may predict the likelihood that the coating will provide improved cell performance.

As described, any electroactive material can be coated using the present invention. The coating can be applied to particulate shaped, planar shaped, and other shaped electroactive materials. The following example illustrates the utility of the coating and details the methods of using the invention. However, the invention is not limited to the materials and methods detailed in the examples.

In aqueous electrolytes, the anode electroactive is often a metal e.g. zinc and aluminum. Zinc alloying is well documented and understood by those skilled in the art as a means to minimize the corrosion reaction of the metal and the aqueous electrolyte. In an aspect, the aluminum is also alloyed. Alloying aluminum with particular elements activates the surface. The purpose of alloying is to both reduce the overpotential for the oxidation by breaking down the passive layer and to increase the overpotential for reduction of water on the surface. The alloying elements found to be effective are those, which are known to be poor catalytic surfaces for hydrogen evolution in their pure state. They have higher nobility than aluminum and low solubility in the aluminum, such as Gallium, Indium, Tin, Zinc, Bismuth, Manganese and Lead. These alloying elements are only effective when present in solid solution form otherwise they tend precipitate as second phase particles and act as localized galvanic cells. Although these alloying elements have very small to zero solubility in aluminum, solid solutions can be created by methods such as melting followed by a rapid quenching, and non-equilibrium techniques such as rapid solidification and ball milling can extensively increase the solubility limit of these elements in aluminum.

The coating can include an electrically conductive additive component, such as a carbon black component, a natural graphite component, a synthetic graphite component, a graphene component, a conductive polymer component, a metal particles component, and/or other like electrically conductive additives. The electrically conductive additive provides an electric conduction network through the coating.

In another aspect, the invention features an ionically conductive coating composition for electroactive particles.

The particle size of the polymer component and the other coating components is important for a consistent and thin coating. Generally, a small particle size, e.g. less than 50% of the coating is desired, and particles less than 10 microns are preferred.

The binder component is detailed in the following examples but not limited to the species or curing methods detailed therein. The binder needs to be inert chemically within the particular cell, and can act to provide cohesion with or without a curing step. There are many such binders which are typically used in the battery industry and which are known to those skilled in the art.

As described, any electroactive material may be coated and the following example provide illustration as the utility of the coating and detail the methods of using the invention. However, the invention is not limited to the materials and methods detailed in the examples.

### Example 9: Zn Coating

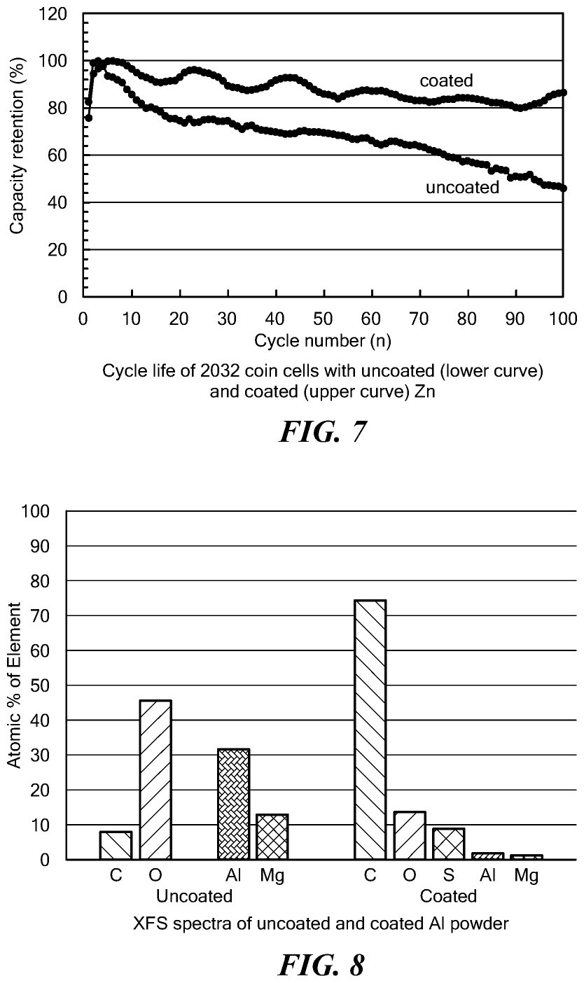

Zinc powder alloyed, with a particle size less than 100 microns from Everzinc was coated using a process (1) including mechanical mixing step with the ionically conductive polymer, an electronically conducting additive(s), and a binding agent, and a cure step. An amount of 40 g of zinc powder was dry mixed with 1.0 g of nano sized (less than 1 micron) IM polymer, 0.7 g of a conductive additive, and 0.3 g of a binding agent. This mixture was then placed in a furnace and heated to a temperature >100° C. but <400° C., for 1 hour before being removed from the furnace. The resulting powder was analyzed by XPS. Comparing uncoated and coated material spectra in FIG. 6 one can see that Zn signal is significantly decreased and replaced with strong signals associated with the ionically conductive polymer. Since XPS penetration depth is limited to 10 nm, complete disappearance of Zn signal would indicate perfect coverage with polymer layer, which is at least 10 nm thick. However, a small Zn peak is still visible, suggesting that not 100% of the Zn surface is covered, that the resulting coating is less than 10 nm thick, or that Zn ions have diffused in to the coating layer. Comparison of Zn peak height in the coated sample to that of uncoated material suggests Zn surface coverage of at least 90%.

### Example 10

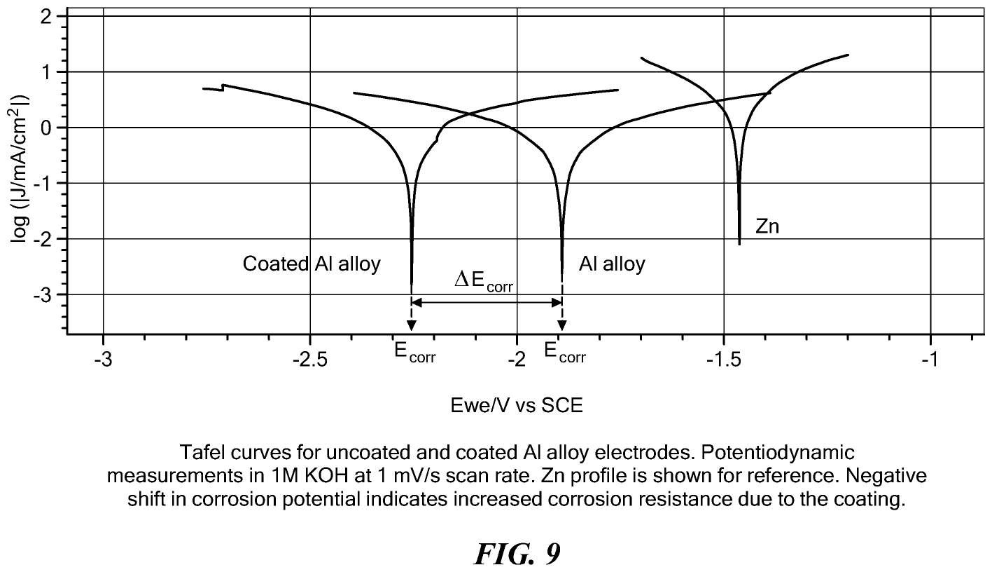

The coated Zn powder from Example 9 was used to make Zn anodes using a slurry casting technique onto a titanium foil, PVDF as the binder, in N-Methyl-2-Pyrrolidone (“NMP”) solution. A control Zn anode was prepared in the same fashion using the pristine Zn powder as received. 2032 coin cells were built using the above two types of zinc anodes, with a common type of manganese dioxide (“MnO₂”) cathode. The cathode was also prepared by a slurry casting technique, containing MnO₂, conductive carbon additives, and PVDF as the binder. Coin cell were all charged to 1.7V and discharged to 0.8V. Cycle life with uncoated Zn anode and coated anode per this invention is shown in FIG. 7. Reduced capacity fade with the coated Zn is obvious.

### Example 11: Aluminum Coating

Aluminum alloy powder (alloyed with Mg, Sn, In and Ga, and with a particle size less than 38 microns) from Phoenix Scientific Industries was coated by first mixing with ionically conductive polymer, an electronically conducting additive(s), and a binding agent, and then curing the coating. Specifically, 40 g of aluminum alloy powder was dry mixed with 1.0 g of nano sized IM polymer, 0.7 g of a conductive additive, and 0.3 g of a binding agent. This mixture was then placed in a furnace and heated to a temperature >100 C but <400 C, for 1 hour before being removed from the furnace.

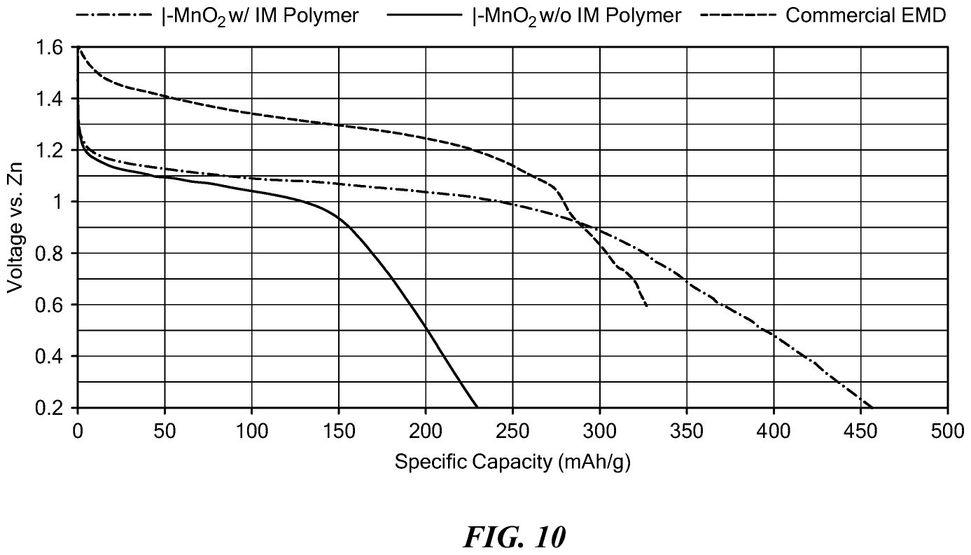

XPS spectra of the coated material are shown in FIG. 8. Effect of coating is similar to that described previously for Zn, Al peak height is decreased and replaced with peaks associated with the coating. Comparison of the Al peak height in coated vs. uncoated material confirms at least 90% surface coverage.

### Example 12

Similar to the procedure described in Example 10, coated Al powder from Example 11 was used to make Al anodes using slurry casting technique onto a titanium foil, PVDF as the binder, in NMP solution. A control Al anode was prepared in the same fashion using the uncoated Al powder. 2032 coin cells were built using the above two types of Al anodes. Zn foil was used as the countering and reference electrode for anodic polarization scans. Scan rate was 1 mV/s.

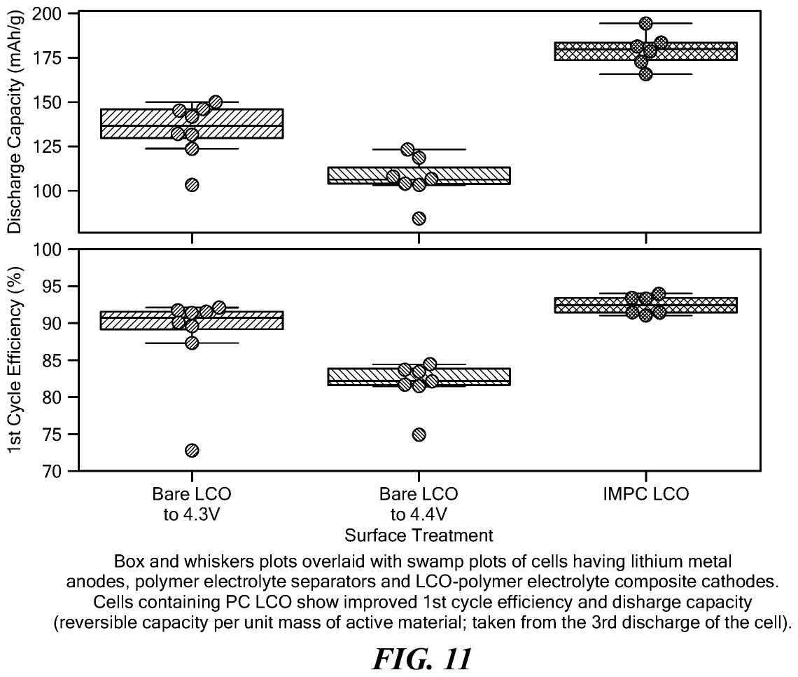

Aluminum should display a very negative thermodynamic electrode potential in alkaline solutions. In practice, however, the open-circuit potential of aluminum is more positive than expected due to self-corrosion. Pure aluminum in an uninhibited electrolyte is unsuitable for use as an electrode since its surface is covered by a passive hydroxide layer, creating high overpotentials. In addition, Aluminum has high corrosion currents as water reduces on preferential sites. Potentiodynamic curves for the uncoated and coated alloyed aluminum are shown in FIG. 9. Also shown is a curve for pure zinc for reference purposes. The open circuit potential (Ecorr) is displayed relative to a reference electrode (Saturated calomel electrode). The coated aluminum powder shows the most corrosion resistance and is almost 0.9 Volts more negative than the zinc. The contribution of the coating is shown by the delta Ecorr arrows, and is greater than 0.35 volts.

### Secondary Cathode Electroactive Coating:

In this example there is detailed a metastable electroactive material that can react with aqueous electrolyte and thus has a very limited electrochemical capacity.

### Example 13

The new synthetic manganese oxide material l-MnO₂ was synthesized by oxidation of anhydrous solid β-MnOOH powder with a dry ozone/oxygen gas mixture. The reaction was performed at room temperature and standard pressure. After 2 molar equivalents of ozone were passed through the reaction vessel, the powder changed color from metallic brown to dull gray. The mechanism of ozone oxidation can involve direct interaction or proceed via radical oxygen intermediates. In the latter case, other gasses containing or producing radical oxygen species can be used in place of ozone (oxygen plasma, OH, gaseous peroxide species, etc.).

Oxidation of Mn(III) to Mn(IV) was confirmed by titration with Ferrous Sulfate, indicating the 4.0 average oxidation state. A coated material was prepared by thoroughly mixing the i-manganese oxide with an ink or coating consisting of an ionically conducting polymer (from Example 1), conductive carbons, and a binder material. The mixture was cured prior to the addition of a conductive graphite. After graphite addition, the material was fully dried. A small amount of liquid potassium hydroxide solution electrolyte was added to the dried material to wet the mixture and the wetted mixture was compacted and granulated to produce a cathode granulate.

### Example 14

A cathode was made by mixing the prepared granulate from Example 13 with electrically conductive carbon powders, and a binder (PVDF or Kynar PVDF with DMA or NMP as a solvent) in desired proportion and slurry-casted onto an electrically conducting (e.g. metal, titanium or stainless steel which has a thin layer of graphite primer to reduce collector to cathode resistance) current collector. The cathode was then dried at 80-120° C. for 2-12 hours, calendared and cut into desired dimensions for coin cells.

Standard CR2032 coin cells were made using the above cathodes. Countering electrodes included zinc anodes, prepared in a similar manner as the cathodes, by mixing zinc powder (ultra-pure powder or alloy powder) with solid, ionically conductive polymer (hereinafter “zinc anode”), conductive carbons, and PVDF binder. Non-woven NKK separators were used. The electrolyte was 25%-45% by weight of KOH solution or 2M zinc sulfate electrolyte containing 0.1M manganese sulfate.

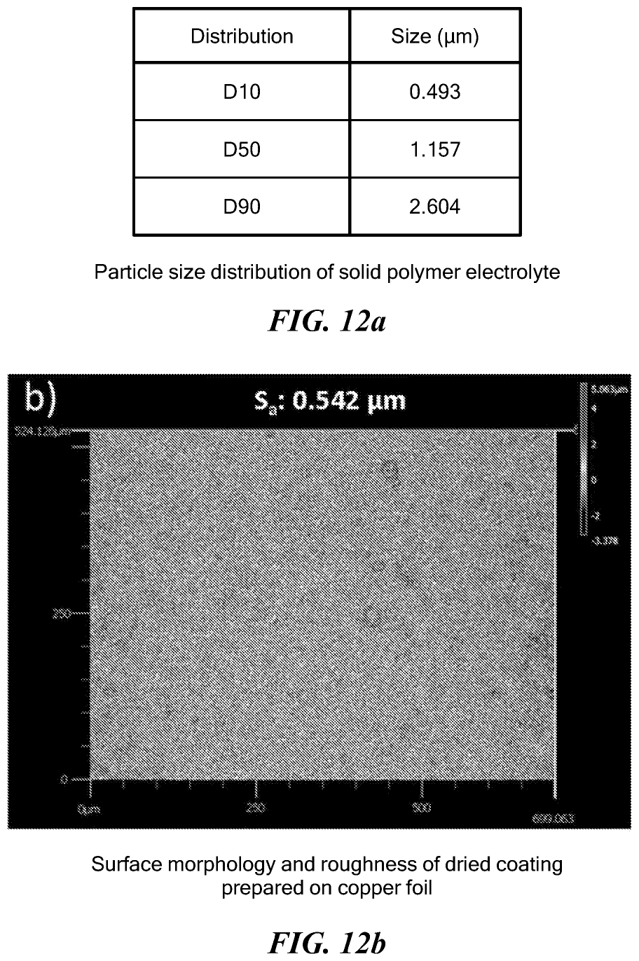

Control cells were built with cathode that contained no solid, ionically conductive polymer. Cells were cycled using constant current charge and discharge, at 3 mA (1.7 mA/cm² current density), between 1.9V to 0.8V or 0.2V. Discharge curves shown below in FIG. 10 demonstrate very low specific capacity for control cell (no solid, ionically conductive polymer), whereas cell per example 12 delivered 450 mAh/g (to 0.2V). Considering a 3.65V oxidation state this implies almost full utilization of the 2^{nd} electron. Stabilizing effect of the coating can be attributed to hindering dissolution of highly soluble t-MnO₂. It is our opinion that the Polymer coating helps to lower surface energy and stabilize the metastable t-MnO₂.

### Lithium Cobalt Oxide (LiCoO₂ or “LCO”) Coating:

LCO is a commonly used cathode material for Li ion batteries. Traditionally, it is charge to 4.2-4.3 V vs. Li and can reversibly deliver 0.5 electron per mole. Charging LCO to higher potential may improve specific capacity over 0.5 e/mole. However, it increases irreversible capacity loss and adversely affects cell cycle life.

PPS and chloranil powder are mixed in a 4.2:1 molar ratio (base polymer monomer to dopant ratio greater than 1:1). The mixture is then heated in argon or air at a high temperature [up to 350° C.] for twenty-four (24) hours at atmospheric pressure. A color change is observed confirming the creation of charge transfer complexes in the polymer-dopant reaction mixture. The reaction mixture is then reground to a small average particle size between 1-40 micrometers. LiTFSI is then mixed with the reaction mixture to create the synthesized solid, ionically conducting polymer material. Via differential scanning calorimetry (“DSC” method described in ASTM D7426 (2013)) the glassy state extends below the temperature range below the material melting temperature to at least room temperature, where the ionic conductivity was found to exceed 1×10⁴ S/cm.

LCO from Umicore was coated by first preparing a polymer-carbon ink, then coating the LCO particles with said ink. To prepare the ink, a known amount of nano-sized solid, ionically conductive polymer and water were combined, so that the solids content was between 7 and 20 wt %. To this mixture a known amount of carbon conductive additives (graphene, graphite, carbon black, carbon nanotubes) in various ratios was incorporated using a high shear mixing method. During the high shear mixing process a binding agent was added and may include an associated curing agent. The resulting material may be referred to as polymer-coated LCO (PC LCO).

### Method 1:

The polymer-carbon ink in an amount of 14.3 g and deionized water in an amount of 14.4 g of were added to a planetary centrifugal mixer. To the same mixer 100.00 g of LCO (Umicore) was added. This material was mixed for 5 minutes at 2000 rpm on a planetary centrifugal mixer. This material was then placed in an oven at 70-90° C. to dry overnight. After drying, the PC LCO was run through a 80 mesh stainless steel sieve.

### Method 2:

A KG-5 mixer (Key International, Inc.) was used to spray the polymer-carbon ink on to the LCO surface. An amount of 300.0 g of LCO (Umicore) was added to a 1 liter mixing bowl. The mixing bowl was sealed and the primary impeller was turned on to begin mixing. A liquid injection port was used to spray in 43 g of polymer-carbon ink. After all of the coating ink had been injected, the secondary high-speed chopper in turned on to break up and granulate the mixture. After the desired granule size was obtained, the mixture was removed from the bowl and dried in an oven between 70-90° C. to dry overnight. After drying, the PC LCO was run through a 80 mesh stainless steel sieve. The PC LCO in this experiment contained about 12 wt % coating before it dried.

### Electrode Coating, Cell Fabrication and Evaluation:

PC LCO was mixed in a planetary centrifugal type mixer (Thinky ARE-310) with carbon black, polyvinylidene difluoride (PVdF) binder, N-Methyl-2-Pyrrolidone (NMP), and solid-electrolyte powder to make a cathode slurry. Alternatively, PC LCO could be mixed in an overhead type mixer, vacuum planetary mixer, or similar.

The cathode slurry was caste onto battery grade aluminum alloy foil (1060 H18, Targray) using a draw-down blade (doctor blade) coater and then dried at 110 C for 4 hours in a convection oven to form PC LCO cathode composites. The PC LCO cathode composites were coated to approx. 1 mAh/cm2 areal loading. Alternatively, the cathode slurry can be coated batch-wise or continuously in a roll-to-roll configuration, for example by contact (reverse comma, slot dye, extrusion) or non-contact (pneumatic spray, electro-spray) techniques, with complimentary drying by convection, IR, vacuum oven, etc.

Control cathode composites were coated onto battery grade aluminum alloy foil (1060 H18, Targray) in the same manner as described above with respect to PC LCO composite cathodes. The control cathode composites did not include PC LCO, but instead included LCO from the same manufacturer lot as the IMPC LCO to compare the effects of the IM polymer-coating material. Cells were assembled using the PC LCO cathode composites and the control cathode composites. Cells comprised a stack inside a 4 mil mylar envelope. Circular punches of cathode composite on aluminum alloy foil and 20 um thick lithium metal coated and rolled on copper foil (Honjo) were used to sandwich IM proprietary polymer electrolyte separator. The polymer electrolyte separator was sandwiched such that lithium metal was adjacent to one side of the separator and cathode composite was adjacent to the separator opposite the lithium metal to make a subassembly. The subassembly was further sandwiched by 0.5 mm thick circular stainless-steel punches, such that one stainless-steel punch was in contact with the aluminum alloy foil of the cathode composite and another stainless-steel punch was in contact with the copper foil of the lithium metal to form the stack. Each stainless-steel punch was welded to a metal tab to enable contact to the stack from leads positioned outside the mylar envelope. Following positioning the stack within the mylar envelope, the stack was sealed within the mylar envelope under 1 atm of pressure using heat. A portion of each metal tab was encapsulated by strip of heal sealing tape co-located and extending beyond an intersection of each metal tab with a seal of the mylar envelope to ensure an air and liquid tight seal. The welded metal tabs were positioned to negotiate between the interior and exterior of the cell and enable the flow of electricity into the stack.

The cells fabricated in the above manner were connected to a battery tester (LANDT) comprising a controllable constant current load and voltage probe. Voltage and current applied were monitored as each cell was charged and discharged three times under a current of C/20 (estimated current necessary to charge the cell to a capacity of 155 mAh/g of active material in twenty hours). Cells were charged from open circuit voltage to a high voltage limit, then discharged to a low voltage limit during a first cycle. During a second and a third cycle, cells were cycled between the high voltage limit and the low voltage limit. Cells comprising bare LCO active material were grouped into two lots, a first lot with a high voltage limit of 4.4 V and a second lot with a high voltage 4.3 V. Both the first and second lots had a low voltage limit of 3 V. Cells comprising IMPC LCO active material had a low voltage limit of 3 V and a high voltage limit of 4.4 V. From the three cycles, initial performance metrics were determined (summarized below in FIG. 6).

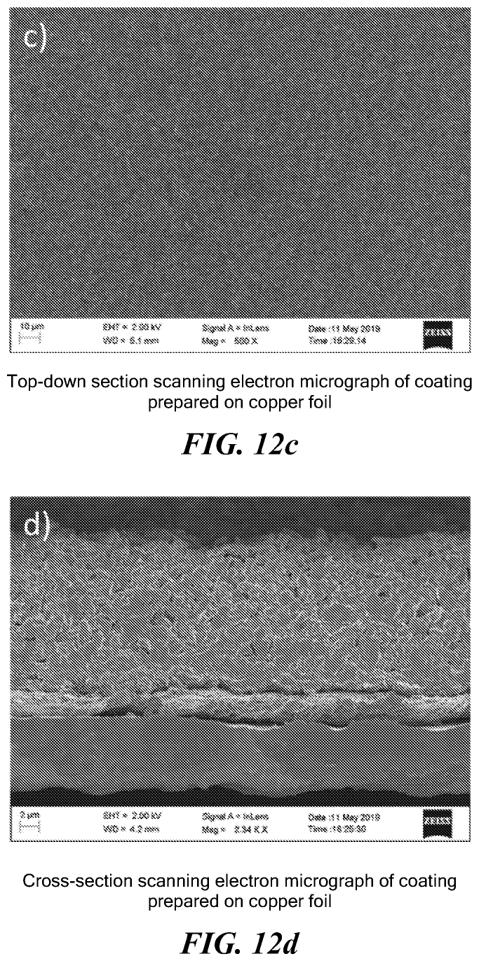

Referring to FIG. 11, cells comprising bare LCO with the high voltage limit of 4.4V were found to have lower first cycle coulombic efficiency (1^{st} cycle efficiency) and lower discharge capacity than cells comprising bare LCO with the low voltage limit of 3.0 V. In some examples this indicates that the cells comprising the bare (uncoated) LCO with the high voltage limit of 4.4 V underwent degradation (i.e., unwanted, parasitic electrochemical reactions). In contrast, cells comprising PC LCO showed increased discharge capacity and first cycle coulombic efficiency compared to cells comprising bare LCO with the high voltage limit of 4.4V.

### Example 15

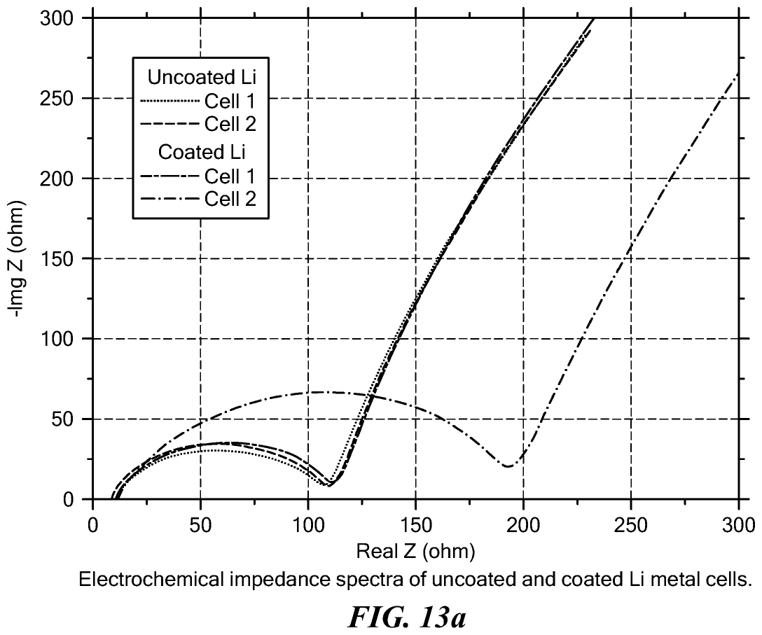

In this example, a planar sheet of lithium metal was coated. The coated lithium metal was either free standing, pre-laminated on a metal current collector, or on treated copper to yield a zero-lithium current collector (for a pre-charged anode). The coating was composed of a binder, solid polymer electrolyte powder having an ionic conductivity of greater than 10⁻⁵ S/cm at room temperature and particles size less than 10 micron. The particle size distribution of the ionically conductive particles is detailed in the table in FIG. 12(a). The coating can also include salts or additives to modify mechanical or electrochemical properties and has a thickness less than 100 microns. The following ingredients were mixed to form a uniform slurry: PVDF (binder) 20% with solid polymer electrolyte 80% was prepared in NMP with a target solids content of 60%. The Lithium metal foil (20 microns, on 8 microns Cu) was coated using a doctor blade, and then dried under vacuum at room temperature for 24 hours. NMP was used, but the solvent is not limited and other solvent can be selected for compatibility with Lithium metal. The coating can be performed via doctor blade, slot die, or other similar coating methods. In this manner multilayer coatings with tuned structural and chemical functions can be prepared by coating lithium electrode.

The surface morphology and roughness of dried coating prepared on copper foil which is illustrated in FIG. 12(b) shows a relatively complete, consistent and smooth coating.

The top-down and cross-section scanning electron micrographs of coating prepared on copper foil which are shown in respective FIGS. 12 (c) and 12(d) show a complete coating which is consistent in thickness and with a smooth top surface.

### Example 16

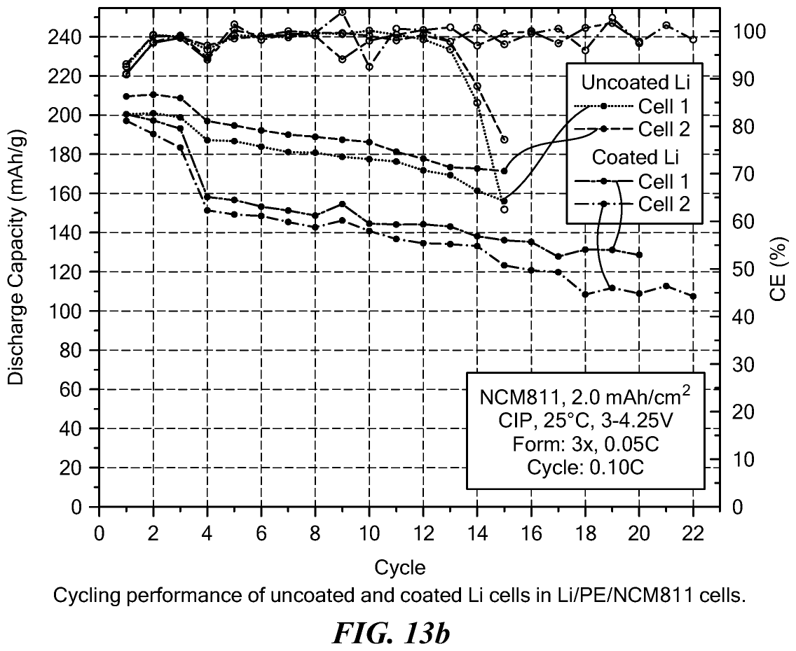

Solid state cells (2 cells of each construction) were constructed using both coated and uncoated lithium metal anodes, along with a NCM811 cathode and a separator (and catholyte) made from the ionically conductive polymer electrolyte. FIG. 13 (a) shows an impedance curve, and FIG. 13 (b) shows a cell performance plot showing discharge capacity (per cycle), cycle number, and columbic efficiency (CE %). Although the impedance of the coated cells appears to be affected, the columbic efficiency is unaffected. Unlike the coated cells which fail after cycle 13, the coated cells continue cycling past cycle 22.

### Example 17

Room temperature experiments were undertaken to determine the fundamental properties of the coating. Electronic conductivity of the coating was measured using DC measurements. A pellet of the coating (created in the various experiments described herein) was placed between blocking electrodes and determined to between 1×10⁻³ and 3×10⁻² S/cm. Ionic conductivity of the coating was also measured using Electrochemical Impedance Spectroscopy (EIS) measurements. A pellet of the coating (created in the various experiments described herein) was placed between blocking electrodes and using ac-impedance measurements, determined to between 4×10⁻³ and 9×10⁻² S/cm. Hydroxyl ion (OH—) diffusivity was measured by creating a membrane of the coating and placing it between two compartments comprising potassium hydroxide. pH monitoring in the two-compartment cell separated by membrane showed diffusivities between 2×10⁻¹° and 2×10⁻⁹ m²/s. From the two-compartment experiment, corresponding molar limiting conductivity was calculated from 0.001 to 0.05 S m2/mol; and respective conductivity with 5M [OH-] is from 0.05 to 0.3 S/cm.

While the invention has been described in detail herein in accordance with certain preferred embodiments, modifications and changes therein may be affected by those skilled in the art without departing from the spirit of the invention. Accordingly, it is the intent to be limited only by the scope of the appending claims and not by way of the details and instrumentalities describing the embodiments shown herein.

It is to be understood that variations and modifications can be made on the compositions, articles, devices, systems, and methods without departing from the concepts of the present invention, and further it is to be understood that such concepts are intended to be covered by the following claims unless these claims by their language expressly state otherwise.

A wide range of further embodiments of the present invention is possible without departing from its spirit and essential characteristics. The embodiments as discussed here are to be considered as being illustrative only in all aspect and not restrictive. The following claims indicate the scope of the invention rather than the foregoing description.

1-19. (canceled)

20. A coating composition comprising:
a plurality of particles of a solid, ionically conductive polymer material;
wherein the solid, ionically conductive polymer material has an ionic conductive greater than 1×10'S/cm at room temperature, and the solid, ionically conductive polymer material is in a glassy state at room temperature;
a plurality of particles of an electrically conductive material;
wherein the electrically conductive material has an electrical conductivity at room temperature greater that 1×10² S/cm; and
a plurality of particles of a binder;
wherein the binder holds the particles of the composition to form a cohesive coating.

21. A coated particle comprising an electroactive particle having a coating having the coating composition of claim 20.

22. The coated particle of claim 21, wherein the coating of the electroactive particle has an average thickness less than 10 microns.

23. The coated particle of claim 21, wherein an average diameter of the plurality of the particles of the solid, ionically conductive material and the plurality of the particles of the electrically conductive material is less than half of a diameter of the electroactive particle.

24. The coated particle of claim 21, wherein the coating covers at least ninety percent of a surface area of the electroactive particle.

25. A plurality of the coated particles of claim 21, wherein each of the plurality of coated particles has adjacent at least one of the plurality of coated particles in both electrical and ionic conductive communication thereof.

26. An electrode comprising the plurality of coated particles of claim 25;
wherein the electrode further comprises a bulk electrolyte;
wherein the bulk electrolyte comprises both an ionically conductive electrolyte and a plurality of electrically conductive particles;
wherein each of the electrically conductive particles is positioned adjacent an exterior surface of at least one of the plurality of coated particles.

27. A battery comprising the electrode of claim 26;
wherein the electrode is an anode; and
wherein at least one electroactive particle of the plurality of coated particles comprises aluminum.

28. The battery of claim 27, further comprising a cathode, wherein the cathode comprises electroactive manganese dioxide.

29. A battery comprising the electrode of claim 26;
wherein the electrode is an anode; and
wherein at least one electroactive particle of the plurality of coated particles comprises zinc.

30. A battery comprising the electrode of claim 26;
wherein the electrode is an cathode; and
wherein at least one electroactive particle of the plurality of coated particles comprises manganese.

31. The battery of claim 29, further comprising a cathode, wherein the cathode comprises electroactive manganese dioxide, and wherein said battery produces at least 3.0 Ampere-hrs while under a 30 milliampere drain to a 0.8V cutoff.

32. A battery comprising the electrode of claim 26;
wherein the electrode is an cathode; and
wherein at least one electroactive particle of the plurality of coated particles comprises lithium.

33. A battery comprising an anode electrode, wherein the electrode comprises lithium metal, wherein the lithium metal is coated with the coating of claim 20.

34. The coating of claim 20, wherein the coating is non-permeable to a material selected from a group consisting of Hataerolite, Hausmannite Aluminum, Zinc, and Manganese.

35. The battery of claim 27, wherein the coating composition provides corrosion resistance of at least 0.35 Volts when potentiodynamically measured in 1M Potassium Hydroxide solution at a 1 mV/s scan rate.

36. The battery of claim 28, wherein the battery is primary.

37. The battery of claim 36, wherein the bulk electrolyte comprises the solid, ionically conductive polymer.

38. The battery of claim 37, wherein the battery is solid state, and does not comprise any liquid electrolyte.
